(19) United States
(12) Patent Application Publication
(10) Pub. No.: US 2025/0070311 A1
(43) Pub. Date: Feb. 27, 2025

(54) VEHICLE BATTERY PACK

(71) Applicant: HONDA MOTOR CO., LTD., Tokyo (JP)

(72) Inventors: Aoi KANNO, Tokyo (JP); Keita Matsuba, Tokyo (JP); Hikaru Morimoto, Tokyo (JP)

(73) Assignee: HONDA MOTOR CO., LTD., Tokyo (JP)

(21) Appl. No.: 18/786,576

(22) Filed: Jul. 29, 2024

(30) Foreign Application Priority Data
Aug. 25, 2023 (JP) 2023-137111

(51) Int. Cl. H01M 10/6566; B60K 1/04; H01M 10/613; H01M 10/625; H01M 10/6563; H01M 50/249; H01M 50/264

(52) U.S. Cl. CPC H01M 10/6566; B60K 1/04; H01M 10/613; H01M 10/625; H01M 10/6563; H01M 50/249; H01M 50/264; B60K 2001/0438

(57) ABSTRACT

A vehicle battery pack includes: a first battery and a second battery disposed apart from each other in a horizontal direction; an electric device electrically connected to the first battery and the second battery; a cooling mechanism configured to cool the first battery and the second battery with cooling air; and a case accommodating the first battery, the second battery, the electric device, and the cooling mechanism, and the cooling mechanism includes a first intake path in which the first battery is disposed and through which the cooling air flows, a second intake path in which the second battery is disposed and through which the cooling air flows, a merging duct as defined herein, and a cooling fan as defined herein, an inclined portion is provided at an upper surface of the merging duct, and the electric device is disposed on the inclined portion.

### CROSS-REFERENCE TO RELATED APPLICATION

This application is based on and claims priority under 35 USC 119 from Japanese Patent Application No. 2023-137111 filed on Aug. 25, 2023.

### TECHNICAL FIELD

The present invention relates to a battery pack to be mounted on a vehicle.

### BACKGROUND ART

In recent years, researches and developments have been conducted on a secondary battery which contributes to improvement in energy efficiency in order to allow more people to have access to affordable, reliable, sustainable and advanced energy.

As a drive source of a vehicle is electrified, a battery that supplies power to a motor or the like is mounted on the vehicle. A battery, various electric devices connected to the battery, a cooling mechanism for cooling the battery and the electric devices, and the like are accommodated in a case and mounted on a vehicle as a unit (for example, JP2018-30450A and JP2013-244768A).

### SUMMARY OF INVENTION

A battery pack is required in which in a limited space inside a case, an electric device serving as a heat generation element is disposed such that the electric device can be appropriately cooled, and an assembly performance of the electric device is good.

An object of the present invention is to provide a vehicle battery pack in which a cooling and assembly performance of an electric device disposed inside a case is good.

The present invention is a vehicle battery pack including:
a first battery and a second battery disposed apart from each other in a horizontal direction;
an electric device electrically connected to the first battery and the second battery;
a cooling mechanism configured to cool the first battery and the second battery with cooling air; and
a case accommodating the first battery, the second battery, the electric device, and the cooling mechanism, in which
the cooling mechanism includes
   a first intake path in which the first battery is disposed and through which the cooling air flows,
   a second intake path in which the second battery is disposed and through which the cooling air flows,
   a merging duct provided between the first battery and the second battery and connected to the first intake path and the second intake path, and
   a cooling fan connected to the merging duct and configured to cause the cooling air to flow through the first intake path, the second intake path, and the merging duct,
an inclined portion is provided at an upper surface of the merging duct, and
the electric device is disposed on the inclined portion.

According to the present invention, a cooling and assembly performance of the electric device disposed inside the case is good.

### BRIEF DESCRIPTION OF DRAWINGS

FIG. 1 is a perspective view of a battery pack 10 according to an embodiment of the present invention.

FIG. 2 is an exploded perspective view of the battery pack 10.

FIG. 3 is a front view of components accommodated in a case 20 of the battery pack 10.

FIG. 4 is a perspective view of a merging duct 50.

FIG. 5 is a view showing a flow of cooling air (broken line arrows) and heat transfer (solid line arrows) in the battery pack 10.

### DETAILED DESCRIPTION OF THE INVENTION

Hereinafter, a vehicle battery pack according to an embodiment of the present invention will be described with reference to the accompanying drawings. The drawings are viewed from directions of reference numerals. In the present description and the like, in order to simplify and clarify the descriptions, front, rear, left, right, up, and down directions are described in accordance with directions viewed from a rider of a vehicle, and in the drawings, a front side of the vehicle is represented by Fr, a rear side is represented by Rr, a left side is represented by L, a right side is represented by R, an upper side is represented by U, and a lower side is represented by D.

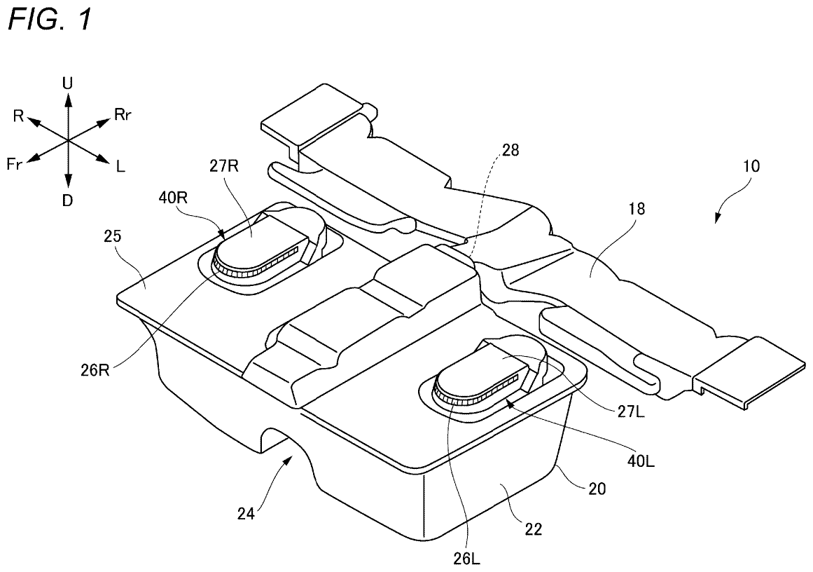

A battery pack 10 shown in FIG. 1 is mounted on an electric vehicle (hereinafter, also simply referred to as a vehicle) such as a hybrid vehicle or an electric automobile. A motor generator is mounted on the vehicle, and the motor generator is driven by electric power stored in the battery pack 10. When the vehicle is decelerated or the like, the battery pack 10 is configured to recover regenerative power from the motor generator.

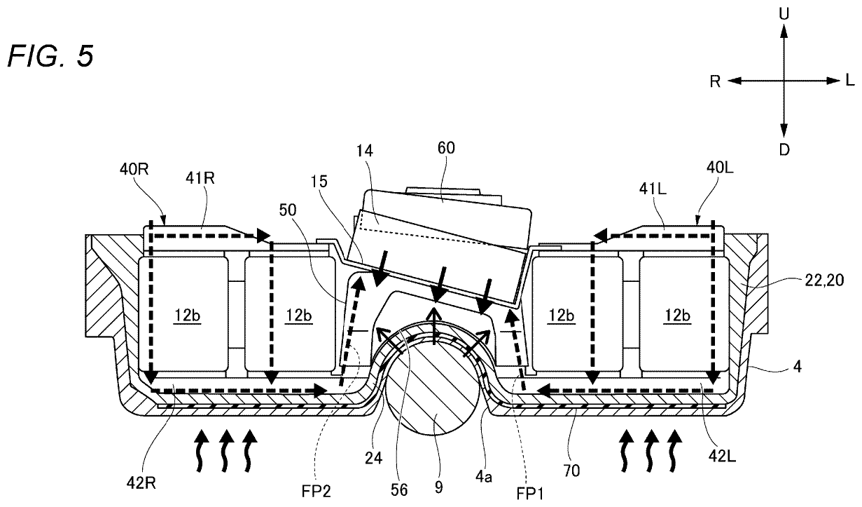

As shown in FIG. 5 to be described later, the battery pack 10 is placed on a floor panel 4 of the vehicle. More specifically, for example, the batter pack 10 is placed on the floor panel 4 at a position below a seat disposed in the passenger compartment.

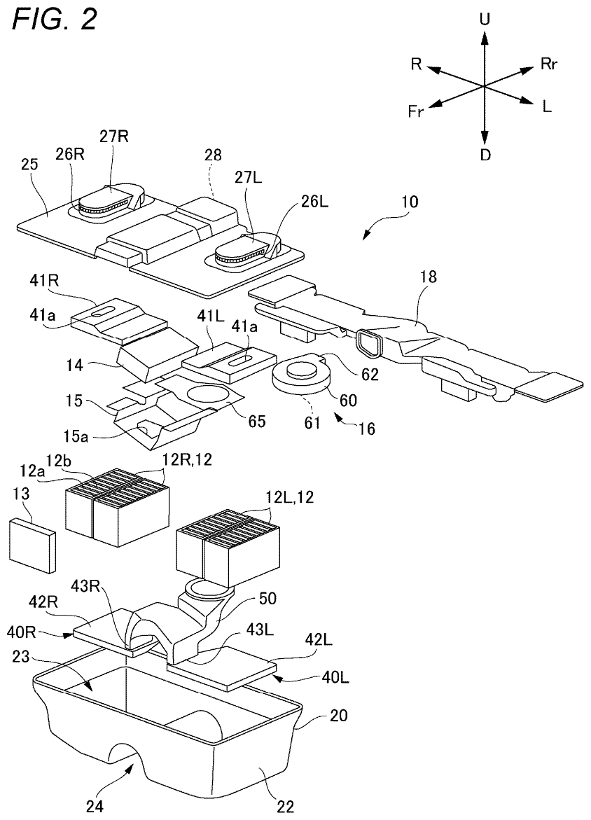

As shown in FIGS. 1 and 2, the battery pack 10 includes four batteries 12, a battery electronic control unit (ECU) 13 that controls charging and discharging of the batteries 12, a junction board 14 on which wiring components through which a charging current and a discharge current of the batteries 12 flow are mounted, a cooling mechanism 16 that cools the batteries 12 by cooling air, an exhaust duct 18 that allows the cooling air that has cooled the batteries 12 to be discharged into the passenger compartment, and a case 20 that accommodates the batteries 12, the battery ECU 13, the junction board 14, and the cooling mechanism 16.

As shown in FIG. 5, the case 20 is placed on the floor panel 4. Specifically, the case 20 is located at a center of the vehicle in a left-right direction, and a propeller shaft 9 of the vehicle extending in a front-rear direction is disposed below the case 20 and the floor panel 4. The propeller shaft 9 transmits a driving force of an engine or a motor generator serving as a drive source of the vehicle to rear wheels.

Returning to FIGS. 1 and 2, the case 20 includes a case main body 22 which is a bottomed container having an opening facing upward, and a lid member 25 which covers the opening of the case main body 22.

An inside of the case main body 22 is an accommodating portion 23 in which the batteries 12, the battery ECU 13, the junction board 14, the cooling mechanism 16, and the like are accommodated. A recess 24 which is recessed upward and in which the propeller shaft 9 is disposed is provided in a lower surface of the case main body 22.

The lid member 25 is a plate-shaped member that closes the opening of the case main body 22. The lid member 25 is provided with a left-side intake 26L and a right-side intake 26R which are disposed at positions separated from each other in the left-right direction, and an exhaust port 28 which is disposed at a center in the left-right direction and on a rear side. The left-side intake 26L and the right-side intake 26R are formed in a left-side grill cover 27L and a right-side grill cover 27R, respectively, and are intake inlets for drawing cooling air in the passenger compartment into the accommodating portion 23 of the case main body 22. The exhaust port 28 is connected to an exhaust duct 18 extending in the left-right direction behind the lid member 25, and the cooling air that has cooled the batteries 12 is dispersed and exhausted to the left and right in the passenger compartment via the exhaust duct 18.

Among the four batteries 12, two batteries 12 are disposed on a right side in the accommodating portion 23 of the case main body 22, and two batteries 12 are disposed on a left side. When the two batteries 12 disposed on the left side are referred to as a left-side battery 12L and the two batteries 12 disposed on the right side are referred to as a right-side battery 12R, the left-side battery 12L and the right-side battery 12R are disposed apart from each other in the left-right direction. The number of the batteries 12 is not limited to four, but at least one battery 12 may be provided on the left side of the case main body 22, and at least one battery 12 may be provided on the right side of the case main body 22.

Each of the batteries 12 includes a plurality of battery cells 12a stacked in the front-rear direction, and is configured as a battery module in which the plurality of stacked battery cells 12a are modularized. Between adjacent battery cells 12a, inter-cell flow paths 12b through which cooling air introduced from the left-side intake 26L and the right-side intake 26R flow are formed along an upper-lower direction. Each of the inter-cell flow paths 12b is opened upward and downward, and front, rear, left and right sides thereof are airtightly closed.

The battery ECU 13 is disposed in front of the right-side battery 12R in the accommodating portion 23 of the case main body 22. The battery ECU 13 includes a processor, a memory, an interface, and the like.

The junction board 14 is disposed between the left-side battery 12L and the right-side battery 12R in the accommodating portion 23 of the case main body 22. The junction board 14 is connected to the batteries 12 via, for example, a bus bar (not shown).

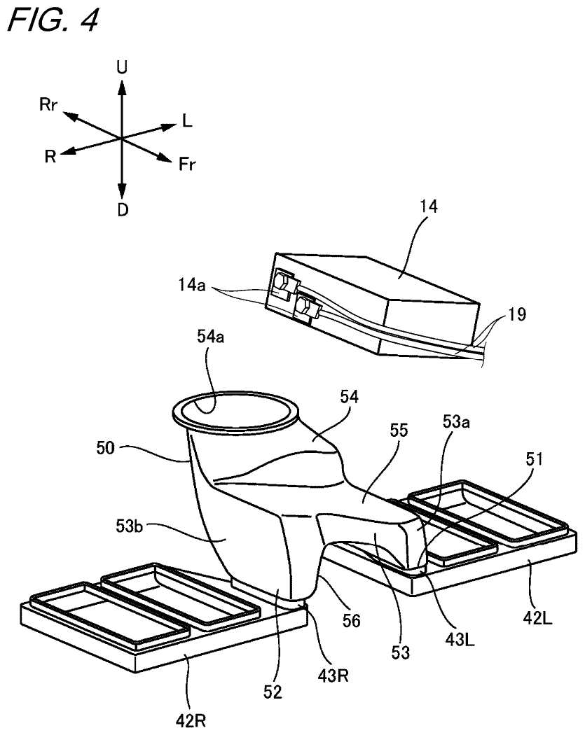

Further, as shown in FIG. 4, terminals 14a to which DC lines 19 are connected are provided on a right surface of the junction board 14. The vehicle is provided with a motor generator and a power control device including an inverter or a DC-DC converter, and the junction board 14 and the power control device are electrically connected to each other via the DC lines 19.

Returning to FIGS. 1 and 2, the cooling mechanism 16 includes a left-side intake path 40L in which the left-side battery 12L is disposed in a path thereof and in which the cooling air drawn from the passenger compartment flows; a right-side intake path 40R in which the right-side battery 12R is disposed in a path thereof and in which the cooling air drawn from the passenger compartment flows; a merging duct 50 that is provided between the left-side battery 12L and the right-side battery 12R and is connected to the left-side intake path 40L and the right-side intake path 40R; and a cooling fan 60 that is connected to the merging duct 50 and causes the cooling air to flow through the right-side intake path 40R, the left-side intake path 40L, and the merging duct 50.

The left-side intake path 40L includes the left-side intake 26L provided in the lid member 25, a left-side upstream duct 41L provided along an upper surface of the left-side battery 12L, the inter-cell flow paths 12b of the left-side battery 12L, and a left-side downstream duct 42L provided along the lower surface of the left-side battery 12L.

The left-side upstream duct 41L is connected to the left-side intake 26L and the inter-cell flow paths 12b of the left-side battery 12L. The left-side upstream duct 41L has an opening 41a at a position corresponding to the left-side intake 26L, and guides the cooling air taken in from the left-side intake 26L to the inter-cell flow paths 12b of the left-side battery 12L.

The left-side downstream duct 42L is connected to the inter-cell flow paths 12b of the left-side battery 12L and the merging duct 50, and guides the cooling air flowing through the inter-cell flow paths 12b to the merging duct 50. The left-side downstream duct 42L includes, at a right-side end portion thereof, a connection portion 43L that is opened upward and connected to the merging duct 50. The connection portion 43L is located forward of a center of the left-side downstream duct 42L in the front-rear direction.

Similarly to the left-side intake path 40L, the right-side intake path 40R includes the right-side intake 26R provided in the lid member 25, a right-side upstream duct 41R provided along an upper surface of the right-side battery 12R, the inter-cell flow paths 12b of the right-side battery 12R, and a right-side downstream duct 42R provided along a lower surface of the right-side battery 12R.

The right-side upstream duct 41R is connected to the right-side intake 26R and the inter-cell flow paths 12b of the right-side battery 12R. The right-side upstream duct 41R has an opening 41a at a position corresponding to the right-side intake 26R, and guides the cooling air taken in from the right-side intake 26R to the inter-cell flow paths 12b of the right-side battery 12R.

The right-side downstream duct 42R is connected to the inter-cell flow paths 12b of the right-side battery 12R and the merging duct 50, and guides the cooling air flowing through the inter-cell flow paths 12b to the merging duct 50. The right-side downstream duct 42R includes, at a left-side end portion thereof, a connection portion 43R that is opened upward and connected to the merging duct 50. The connection portion 43R is located forward of a center of the right-side downstream duct 42R in the front-rear direction.

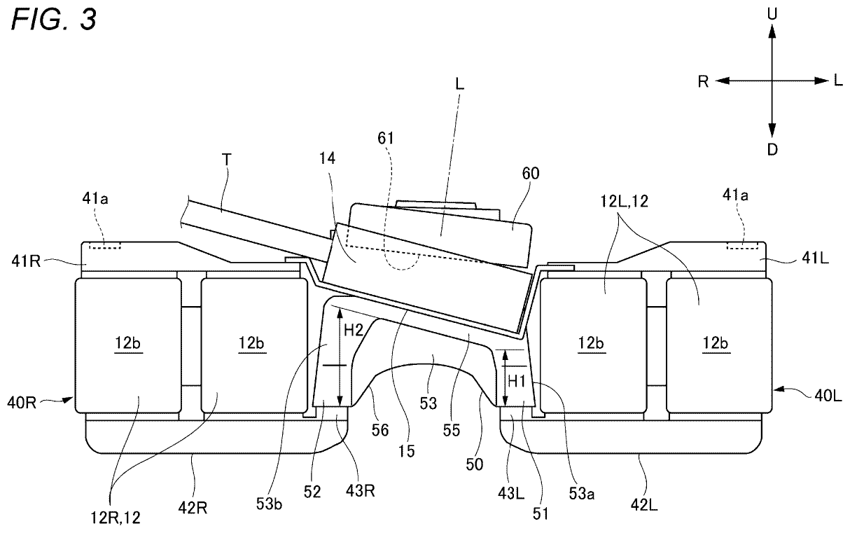

As shown in FIGS. 3 and 4, the merging duct 50 includes a left-side connection portion 51 connected to the connection portion 43L of the left-side downstream duct 42L, a right-side connection portion 52 connected to the connection portion 43R of the right-side downstream duct 42R, a merging portion 53 where the cooling air introduced from the left-side connection portion 51 and the right-side connection portion 52 merges, a fan connection portion 54 provided downstream of the merging portion 53 and connected to the cooling fan 60, and an inclined portion 55 provided at an upper surface of the merging duct 50.

The left-side connection portion 51 and the right-side connection portion 52 each have an opening facing downward, and are respectively provided a the left-side lower portion and a right-side lower portion of the merging portion 53.

The merging portion 53 forms a flow path extending upward and rearward from the left-side connection portion 51 and the right-side connection portion 52 to the fan connection portion 54. A height H1 of a left-side end portion 53a of the merging portion 53 (that is, a length from the left-side connection portion 51 to an upper end of the left-side end portion 53a) is smaller than a height H2 of the right-side end portion 53b of the merging portion 53 (that is, a length from the right-side connection portion 52 to an upper end of the right-side end portion 53b). In other words, the upper end of the left-side end portion 53a is located lower than the upper end of the right-side end portion 53b, and the merging portion 53 is configured to be left-right asymmetrical.

The fan connection portion 54 is provided at a rear portion of the merging portion 53, and forms a flow path extending upward. The fan connection portion 54 has an opening 54a facing upward, and the cooling fan 60 is connected to the fan connection portion 54 from above via a fan bracket 65 (see FIG. 2).

The inclined portion 55 is provided at the upper surface of the merging portion 53. As described above, since the upper end of the left-side end portion 53a of the merging portion 53 is located lower than the upper end of the right-side end portion 53b, the inclined portion 55 is inclined to be lowered from a right side toward a left side. In other words, the inclined portion 55 is inclined toward the left-side battery 12L in a direction in which the left-side battery 12L and the right-side battery 12R are arranged.

In the present embodiment, the junction board 14 is disposed on the inclined portion 55 provided at the upper surface of the merging duct 50.

Since the junction board 14 is disposed on the upper surface of the merging duct 50, heat from the junction board 14 that generates heat is received by the merging duct 50, and thus the junction board 14 can be appropriately cooled. In particular, since the inclined portion 55 is provided at the upper surface of the merging duct 50, that is, a heat receiving surface, as compared with a case where the inclined portion 55 is not provided, a surface area of the heat receiving surface can be increased, and cooling efficiency of the junction board 14 is improved.

When the junction board 14 is placed directly in a flow path through which cooling air flows and is cooled, the number of ducts may increase in order to provide a flow path that passes through the junction board 14, but in the present embodiment, the junction board 14 is disposed outside the flow path of the cooling air to cool the junction board 14, so the number of ducts can be reduced, which contributes to cost reduction and miniaturization of the battery pack 10.

Further, since the junction board 14 is disposed on the inclined portion 55, a tool T to be used at the time of assembly can be easily accessed to the junction board 14 in a narrow space between the left-side battery 12L and the right-side battery 12R. Thus, as compared with a case where the junction board 14 is disposed horizontally, an assembly performance of the junction board 14 is improved.

In a more detailed description of the assembly performance of the junction board 14, the junction board 14 is provided with the terminals 14a on the right side, which is a higher side of the inclined portion 55, and when the DC lines 19 are fixed to the terminals 14a by a fastening member, a work space for the tool T can be secured above the right-side battery 12R.

The junction board 14 is supported by a frame member 15 provided along the inclined portion 55, that is, is disposed on the inclined portion 55 of the merging duct 50 via the frame member 15.

The frame member 15 is a sheet metal member that supports the junction board 14 from below, and is fixed to, for example, the battery 12 or another frame member attached to the battery 12. Further, the frame member 15 is provided with a through hole 15a (see FIG. 2) in a surface facing a lower surface of the junction board 14.

The junction board 14 is supported by the frame member 15 with a predetermined gap between the junction board 14 and the inclined portion 55 of the merging duct 50. Accordingly, an air layer can be provided between the junction board 14 and the inclined portion 55, and the junction board 14 can be efficiently cooled. The frame member 15 does not necessarily need to be provided, for example, the junction board 14 may be directly placed on the inclined portion 55 of the merging duct 50.

The inclined portion 55 is located at a lower position than the upper surfaces of the left-side battery 12L and the right-side battery 12R. Accordingly, an increase in a length dimension of the battery pack 10 in the upper-lower direction when the junction board 14 is disposed on the inclined portion 55 can be prevented.

The cooling fan 60 is, for example, a sirocco fan, and includes therein an impeller (not shown) rotatable around a rotation axis L, an intake port 61 opened downward, and a blow-out port 62 (see FIG. 2) opened rearward. The intake port 61 is connected to the fan connection portion 54 of the merging duct 50, and draws in the cooling air by rotation of the impeller. The blow-out port 62 is connected to the exhaust duct 18, and discharges the cooling air drawn from the intake port 61 to the exhaust duct 18.

The cooling fan 60 is inclined toward the same side as the side toward which the inclined portion 55 is inclined, that is, the left side. Specifically, the fan connection portion 54 of the merging duct 50 is inclined toward the same side as the side toward which the inclined portion 55 is inclined, that is, toward the left side, and the cooling fan 60 is connected to the fan connection portion 54 via the fan bracket 65 so as to be inclined toward the left side.

Broken line arrows in FIG. 5 indicate flows of the cooling air flowing through the left-side intake path 40L, the right-side intake path 40R, and the merging duct 50. Since the inclined portion 55 inclined toward the left side is provided at the upper surface of the merging duct 50, among a flow path in the merging duct 50, a path FP1 of the cooling air introduced from the left-side intake path 40L and flowing on the left side is shorter than a path FP2 of the cooling air introduced from the right-side intake path 40R and flowing on the right side, and a path difference occurs. Therefore, by providing the cooling fan 60 to be inclined toward the same side as the side toward which the inclined portion 55 is inclined, that is, toward the left side, a flow of the cooling air in the merging duct 50 that is based on the path difference can be made close to uniform, and occurrence of turbulence in the merging duct 50 can be prevented.

As shown in FIG. 5, the propeller shaft 9 provided in a drive system of the vehicle is disposed below the case 20 and the floor panel 4. Specifically, the case main body 22 is provided with the recess 24, and the floor panel 4 is provided with a recess 4a that is recessed upward and extends along the front-rear direction. The propeller shaft 9 is disposed in the recess 24 of the case main body 22 and the recess 4a of the floor panel 4.

Since the propeller shaft 9 generates heat due to rotation, the battery pack 10 receives the heat from the propeller shaft 9 as indicated by solid arrows in FIG. 5. Further, for example, in a high-temperature environment, the battery pack 10 receives heat from a road surface.

Therefore, a heat insulating material 70 is provided between the case 20 and the floor panel 4. In the present embodiment, the heat insulating material 70 is provided to cover an entire lower surface of the case main body 22 including the recess 24. Accordingly, the battery 12, the junction board 14, and the like can be prevented from being affected by heat from below the battery pack 10. The heat insulating material 70 may be provided only at a position overlapping the propeller shaft 9 in a top view on the lower surface of the case main body 22. Accordingly, the battery 12, the junction board 14, and the like can be prevented from being affected by the heat from the propeller shaft 9.

The merging duct 50 is disposed at a position overlapping the propeller shaft 9 of the vehicle in a top view. Accordingly, the heat from the propeller shaft 9 can be received by the merging duct 50, and the junction board 14 can be further prevented from being affected by the heat from the propeller shaft 9.

Further, a recess 56 recessed upward is provided in a lower surface of the merging portion 53 of the merging duct 50. The recess 56 of the merging portion 53 is provided along the recess 24 of the case main body 22. With such a configuration, a surface area of the merging duct 50 facing the propeller shaft 9 can be increased, so that the battery 12, the junction board 14, and the like can be further prevented from being affected by the heat from the propeller shaft 9.

Although one embodiment of the present invention has been described above with reference to the accompanying drawings, it is needless to say that the present invention is not limited to the embodiment. It is apparent that those skilled in the art can conceive of various modifications and alterations within the scope described in the claims, and it is understood that such modifications and alterations naturally fall within the technical scope of the present invention. In addition, the components in the above embodiments may be combined as desired without departing from the gist of the invention.

For example, in the above-described embodiment, the junction board 14 is disposed on the inclined portion 55 of the merging duct 50, but the present invention is not limited thereto. For example, another electric device, for example, the battery ECU 13 may be disposed on the inclined portion 55. When the battery pack 10 includes, for example, an inverter or a DC-DC converter, the inverter or the DC-DC converter may be disposed on the inclined portion 55 of the merging duct 50.

In this specification, at least the following matters are described. In parentheses, corresponding components and the like in the above embodiment are illustrated as an example, but the present invention is not limited thereto.

(1) A vehicle battery pack (battery pack 10), including:
a first battery (left-side battery 12L) and a second battery (right-side battery 12R) disposed apart from each other in a horizontal direction;
an electric device (junction board 14) electrically connected to the first battery and the second battery;
a cooling mechanism (cooling mechanism 16) configured to cool the first battery and the second battery with cooling air; and
a case (case 20) accommodating the first battery, the second battery, the electric device, and the cooling mechanism, in which
the cooling mechanism includes
   a first intake path (left-side intake path 40L) in which the first battery is disposed and through which the cooling air flows,
   a second intake path (right-side intake path 40R) in which the second battery is disposed and through which the cooling air flows,
   a merging duct (merging duct 50) provided between the first battery and the second battery and connected to the first intake path and the second intake path, and
   a cooling fan (cooling fan 60) connected to the merging duct and configured to cause the cooling air to flow through the first intake path, the second intake path, and the merging duct,
an inclined portion (inclined portion 55) is provided at an upper surface of the merging duct, and
the electric device is disposed on the inclined portion.

According to (1), since the electric device is disposed on the upper surface of the merging duct, heat from the electric device is received by the merging duct, and thus the electric device can be cooled. In addition, since the inclined portion is provided at the upper surface of the merging duct and the electric device is disposed on the inclined portion, a tool to be used at the time of assembling the electric device can easily access the electric device, and an assembly performance of the electric device is good.

(2) The vehicle battery pack according to (1), in which
the electric device is provided with a terminal (terminal 14a), to which a wiring (DC line 19) is to be connected, at a higher side of the inclined portion.

According to (2), a work space for a tool to be used when the wiring is assembled to the electric device can be secured at the higher side of the inclined portion.

(3) The vehicle battery pack according to (1) or (2), further including:
a frame member (frame member 15) that is provided along the inclined portion and supports the electric device, in which
the electric device is supported by the frame member with a predetermined gap between the electric device and the inclined portion of the merging duct.

According to (3), since an air layer can be provided between the electric device and the inclined portion, the electric device can be efficiently cooled.

(4) The vehicle battery pack according to any one of (1) to (3), in which
the inclined portion is located at a lower position than upper surfaces of the first battery and the second battery.

According to (4), an increase in a length dimension of the battery pack in an upper-lower direction can be prevented.

(5) The vehicle battery pack according to any one of (1) to (4), in which
the inclined portion is inclined toward one of the first battery and the second battery.

According to (5), a work space of the tool to be used for assembling the electric device can be secured above the first battery or the second battery.

(6) The vehicle battery pack according to (5), in which
the inclined portion is inclined toward the first battery,
the merging duct is configured such that a path (path FP1) of the cooling air flowing at a side of the first battery is shorter than a path (path FP2) of the cooling air flowing at a side of the second battery, and
the cooling fan is inclined toward the same side as the side toward which the inclined portion is inclined.

According to (6), since the cooling fan is provided to be inclined toward the same side as the side toward which the inclined portion is inclined, a flow in the merging duct that is based on a path difference in the merging duct can be made close to uniform.

(7) The vehicle battery pack according to any one of (1) or (6), in which
the case is placed on a floor panel (floor panel 4) of a vehicle,
a power transmission shaft (propeller shaft 9) provided in a drive system of the vehicle is disposed below the case and the floor panel, and
a heat insulating material (heat insulating material 70) is provided between the case and the floor panel at least at a position overlapping the power transmission shaft in a top view.

According to (7), by providing the heat insulating material, heat from the power transmission shaft, which is a heat generation element, can be prevented from affecting the battery and the electric device accommodated in the case.

(8) The vehicle battery pack according to any one of (1) to (7), in which
the case is placed on a floor panel (floor panel 4) of a vehicle,
a power transmission shaft (propeller shaft 9) provided in a drive system of the vehicle is disposed below the case and the floor panel, and
the merging duct is disposed at a position overlapping the power transmission shaft in a top view.

According to (8), since the merging duct is disposed between the electric device and the power transmission shaft, the electric device can be prevented from being affected by the heat from the power transmission shaft.

(9) The vehicle battery pack according to (8), in which
at lower surfaces of the case and the floor panel, a recess (recess 24, recess 4a) which is recessed upward and in which the power transmission shaft is disposed is provided, and
the merging duct is provided along the recess.

According to (9), a surface area of the merging duct facing the power transmission shaft can be increased, and the battery, the electric device, and the like accommodated in the case can be prevented from being affected by the heat from the power transmission shaft.

(10) The vehicle battery pack according to any one of (1) to (9), in which
the electric device is a junction board electrically connected to the first battery and the second battery.

According to (10), the junction board can be cooled by the merging duct.

### REFERENCE SIGNS LIST

4: FLOOR PANEL
9: PROPELLER SHAFT (POWER TRANSMISSION SHAFT)
10: BATTERY PACK (VEHICLE BATTERY PACK)
12L: LEFT-SIDE BATTERY (FIRST BATTERY)
12R: RIGHT-SIDE BATTERY (SECOND BATTERY)
14: JUNCTION BOARD (ELECTRIC DEVICE)
14a: TERMINAL
15: FRAME MEMBER
16: COOLING MECHANISM
19: DC LINE (WIRING)
20: CASE
40L: LEFT-SIDE INTAKE PATH (FIRST INTAKE PATH)
40R: RIGHT-SIDE INTAKE PATH (SECOND INTAKE PATH)
50: MERGING DUCT
55: INCLINED PORTION
60: COOLING FAN
70: HEAT INSULATING MATERIAL
FP1: PATH
FP2: PATH

What is claimed is:

1. A vehicle battery pack comprising:
a first battery and a second battery disposed apart from each other in a horizontal direction;
an electric device electrically connected to the first battery and the second battery;
a cooling mechanism configured to cool the first battery and the second battery with cooling air; and
a case accommodating the first battery, the second battery, the electric device, and the cooling mechanism, wherein
the cooling mechanism includes
a first intake path in which the first battery is disposed and through which the cooling air flows,
a second intake path in which the second battery is disposed and through which the cooling air flows,
a merging duct provided between the first battery and the second battery and connected to the first intake path and the second intake path, and
a cooling fan connected to the merging duct and configured to cause the cooling air to flow through the first intake path, the second intake path, and the merging duct,
an inclined portion is provided at an upper surface of the merging duct, and
the electric device is disposed on the inclined portion.

2. The vehicle battery pack according to claim 1, wherein
the electric device is provided with a terminal, to which a wiring is to be connected, at a higher side of the inclined portion.

3. The vehicle battery pack according to claim 1, further comprising:
a frame member that is provided along the inclined portion and supports the electric device, wherein
the electric device is supported by the frame member with a predetermined gap between the electric device and the inclined portion of the merging duct.

4. The vehicle battery pack according to claim 2, further comprising:
a frame member that is provided along the inclined portion and supports the electric device, wherein
the electric device is supported by the frame member with a predetermined gap between the electric device and the inclined portion of the merging duct.

5. The vehicle battery pack according to claim 1, wherein
the inclined portion is located at a lower position than upper surfaces of the first battery and the second battery.

6. The vehicle battery pack according to claim 2, wherein
the inclined portion is located at a lower position than upper surfaces of the first battery and the second battery.

7. The vehicle battery pack according to claim 1, wherein
the inclined portion is inclined toward one of the first battery and the second battery.

8. The vehicle battery pack according to claim 2, wherein
the inclined portion is inclined toward one of the first battery and the second battery.

9. The vehicle battery pack according to claim 7, wherein
the inclined portion is inclined toward the first battery,
the merging duct is configured such that a path of the cooling air flowing at a side of the first battery is shorter than a path of the cooling air flowing at a side of the second battery, and
the cooling fan is inclined toward a same side as a side toward which the inclined portion is inclined.

10. The vehicle battery pack according to claim 8, wherein
the inclined portion is inclined toward the first battery,
the merging duct is configured such that a path of the cooling air flowing at a side of the first battery is shorter than a path of the cooling air flowing at a side of the second battery, and
the cooling fan is inclined toward a same side as a side toward which the inclined portion is inclined.

11. The vehicle battery pack according to claim 1, wherein
the case is placed on a floor panel of a vehicle,
a power transmission shaft provided in a drive system of the vehicle is disposed below the case and the floor panel, and
a heat insulating material is provided between the case and the floor panel at least at a position overlapping the power transmission shaft in a top view.

12. The vehicle battery pack according to claim 2, wherein
the case is placed on a floor panel of a vehicle,
a power transmission shaft provided in a drive system of the vehicle is disposed below the case and the floor panel, and
a heat insulating material is provided between the case and the floor panel at least at a position overlapping the power transmission shaft in a top view.

13. The vehicle battery pack according to claim 1, wherein
the case is placed on a floor panel of a vehicle,
a power transmission shaft provided in a drive system of the vehicle is disposed below the case and the floor panel, and
the merging duct is disposed at a position overlapping the power transmission shaft in a top view.

14. The vehicle battery pack according to claim 2, wherein
the case is placed on a floor panel of a vehicle,
a power transmission shaft provided in a drive system of the vehicle is disposed below the case and the floor panel, and
the merging duct is disposed at a position overlapping the power transmission shaft in a top view.

15. The vehicle battery pack according to claim 13, wherein
at lower surfaces of the case and the floor panel, a recess which is recessed upward and in which the power transmission shaft is disposed is provided, and
the merging duct is provided along the recess.

16. The vehicle battery pack according to claim 14, wherein
at lower surfaces of the case and the floor panel, a recess which is recessed upward and in which the power transmission shaft is disposed is provided, and
the merging duct is provided along the recess.

17. The vehicle battery pack according to claim 1, wherein
the electric device is a junction board electrically connected to the first battery and the second battery.

18. The vehicle battery pack according to claim 2, wherein
the electric device is a junction board electrically connected to the first battery and the second battery.
